(19) United States
(12) Patent Application Publication
(10) Pub. No.: US 2004/0243711 A1
(43) Pub. Date: Dec. 2, 2004

(54) Method, system and network element for controlling data transmission in a network environment

(76) Inventor: Jaakko Rajaniemi, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/488,594

(22) PCT Filed: Sep. 11, 2001
(86) PCT No.: PCT/EP01/10504

(51) Int. Cl. G06F 15/16

(52) U.S. Cl. 709/227; 370/352; 379/93.17; 455/406

(57) ABSTRACT

The invention relates to a method, a system and a network element for controlling data transmission in a network environment comprising a first control function I-CSCF 206 and a second control function S-CSCF 203. In order to optimise the network resource usage the second control function S-CSCF 203 is allocated by said first control function I-CSCF 206 dynamically when a network transaction is processed. Thus, network resources are saved as a permanent allocation of the second control function S-CSCF 203 is avoided.

### FIELD OF THE INVENTION

The present invention relates to a method, a system and a network element for controlling data transmission in a network environment such as in UMTS (Universal Mobile Telecommunications System) networks.

### BACKGROUND OF THE INVENTION

Internet Protocol Multimedia Subsystems (IMS) have been developed to support IP (Internet Protocol) Multimedia (IM) services in UMTS. Such IMSs have been developed with an attempt to conform to internet standards set out by the IETF (Internet Engineering Task Force), in order to achieve access independence and to maintain a smooth interoperation with wireless terminals across the internet. Therefore, interfaces specified conform as far as possible to IETF standards for those cases where an IETF protocol has been selected, e.g. the session initiation protocol (SIP) as defined in “SIP: Session Initiation Protocol”, IETF document RFC2543 by Handley/Schulzrinne/Schooler/Rosenberg.

The session initiation protocol is used to establish multimedia sessions or calls, e.g. VoIP (Voice over Internet Protocol) sessions. The session initiation protocol is a request-response control (signalling) protocol for initiating, maintaining and terminating sessions with one or more participants or terminal devices. The session initiation protocol uses session initiation messages to negotiate between participants or terminal devices.

The IMS enables operators of mobile networks to offer their subscribers multimedia services based on and build upon internet applications, services, and protocols. There are two possible scenarios to provide services, i.e. via the service platform in the home network or via an external service platform, e.g. a third party or visited network.

Session control functions as call state control functions (CSCFs) are provided which can act as proxy CSCFs (P-CSCFs), serving CSCF (S-CSCFs) or interrogating CSCFs (I-CSCFs). The P-CSCF is the first contact point for a user or user equipment (UE) within the IMS. The S-CSCF actually handles the session states in the network. The I-CSCF is mainly the contact point within an operator's network for all connections destined to a subscriber of that network operator. A more detailed description of the IMS can be gathered from the 3GPP (Third generation partnership project) specification TS 23.228 “Technical Specification Group Services and System Aspects—IP Multimedia (IM) Subsystem—Stage 2”.

In the conventional IMS the S-CSCF is allocated permanently in the registration of a user equipment. As this allocation is done for each user equipment a corresponding large amount of network resources is needed while the network resources are not used in an efficient manner.

### SUMMARY OF THE INVENTION

It is therefore an object of the present invention to improve the efficiency of network resource usage.

This object is achieved by a method for controlling data transmission in a network environment by means of a first control function and a second control function, said method comprising the step of said first control function allocating said second control function dynamically when a network transaction is processed.

Furthermore, the above object is achieved by a system for controlling data transmission in a network environment, comprising a first control function and a second control function, said first control function comprising allocating means for allocating said second control function dynamically when a network transaction is processed.

Furthermore, the above object is achieved by a network element for controlling data transmission in a network environment and for use in such a method and/or in such a system, the network element comprising a control function, said control function comprising allocating means for allocating a second control function dynamically when a network transaction is processed.

The present invention has realized that during data transmission in a network environment, such as during sessions between users or during user registration, the above mentioned second control function, e.g. a S-SCSF, is needed only under certain circumstances, namely when a network transaction is processed such as when any kind of transaction within the network, e.g. any kind of data exchange, in particular message exchange between users and/or network elements, is activated or terminated during a session, in particular when a session is setup or terminated for a user or when a user is registering.

When a user is registering, the S-CSCF may be allocated in order to prepare for the incoming session setups, i.e. user originated or terminated session setup. The preparation of the S-CSCF means that e.g. the user profile information is downloaded to the S-CSCF. However, the preparation may also be performed dynamically when the session is setup.

During the time when a user does not have any active sessions there is no need for that second control function (e.g. S-CSCF), and an allocation of that second control function by the first control function (e.g. I-CSCF) merely uses resources of the second control function (e.g. S-CSCF) and its database because the second control function stores subscriber specific information that is momentarily not needed. However, such a permanent allocation of the second control function (e.g. S-CSCF) does not have any reasonable advantage.

Therefore, the invention proposes to allocate the second control function (e.g. S-CSCF) dynamically, i.e. only occasionally, namely only during such conditions when it is actually needed. Thus, a permanent allocation is avoided and network resources can be saved and hence the network resource usage is optimised as no second control function (e.g. S-CSCF) is reserved for inactive users that do not actually need the second control function (e.g. S-CSCF).

A further advantage of the present invention is the fact that no data is lost as a result of second control function (e.g. S-CSCF) resets when such resets are performed at a time when this second control function has not been allocated.

Preferably, the decision of whether or not to allocate said second control function is made

either by or in said first control function or by or in a first network element comprising said first control function,

or by or in a further control function or by or in a further network element comprising said further control function.

Thereby the decision can be made on logical and/or on physical levels. Thus, as an example the further network element/further control function could decide that the second control function is allocated dynamically (or not) and the first control function makes the actual allocation of the second control function if decided by the further network element/further control function. Thereby, the control functions may be co-located, especially the first and the further control function may be co-located.

Further advantageous developments of the present invention are defined in the dependent claims.

### BRIEF DESCRIPTION OF THE DRAWINGS

In the following, the present invention will be described in greater detail based on preferred embodiments with reference to the accompanying drawings, in which:

FIG. 1 shows a signaling diagram indicating an IM subscriber registration according the prior art;

FIG. 2 shows a signaling diagram indicating an IM subscriber registration according to a first embodiment of the present invention;

FIG. 3 shows a signaling diagram indicating an mobile originated connection setup according to a second embodiment of the present invention; and

FIG. 4 shows a signaling diagram indicating a mobile terminated connection setup according to a third embodiment of the present invention.

### DESCRIPTION OF THE PREFERRED EMBODIMENTS

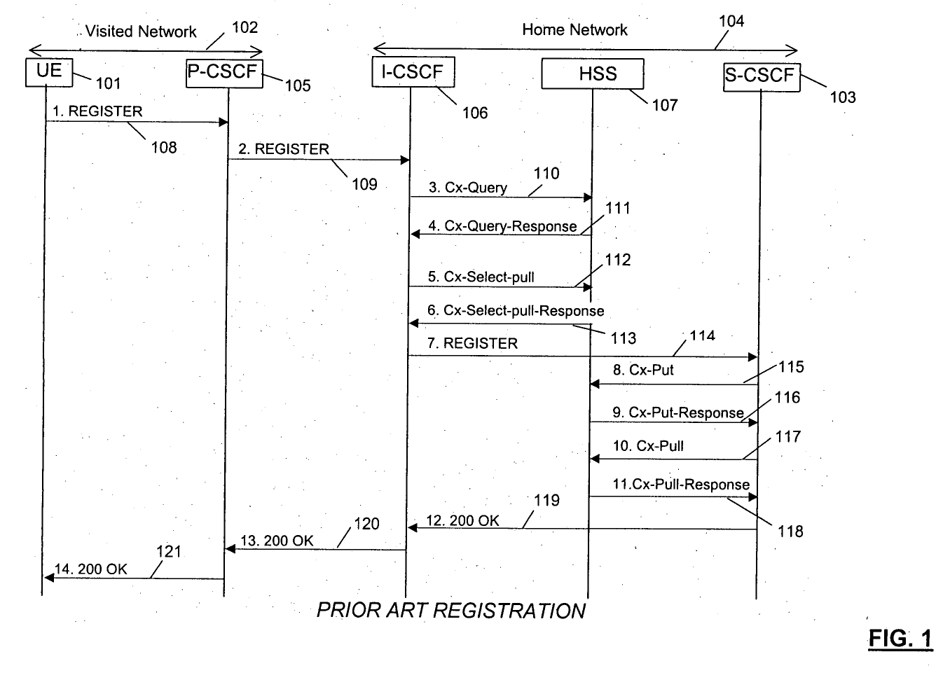

The preferred embodiments will be described hereinafter. However, a prior art registration procedure is described first with reference to FIG. 1 in order to ease the understanding of the present invention.

When a subscriber, e.g. a corresponding user equipment 101, roams to a visited network 102, a session control function, namely a S-CSCF 103 is located in the home network 104 of the subscriber, while the visited network 102 supports another session control function, namely a P-CSCF 105. The P-CSCF 105 enables the session control to be passed to the home network based S-CSCF 103 which provides the service control. Another session control function, namely an I-CSCF 106 can be used in the SIP signaling path to shield the internal structure of a network from other networks. An I-CSCF 106 is therefore located at the home network 104 location.

Furthermore, at the home network 104 location a further control function, namely a home subscriber server (HSS) 107 is provided which substitutes a home location register (HLR) when the IMS is implemented. The HSS 107 is a master database for a given user and contains the subscription related information to support the network entities actually handling calls or sessions. Furthermore, subscriber related data may be stored in the S-CSCF 103 and the P-CSCF 105.

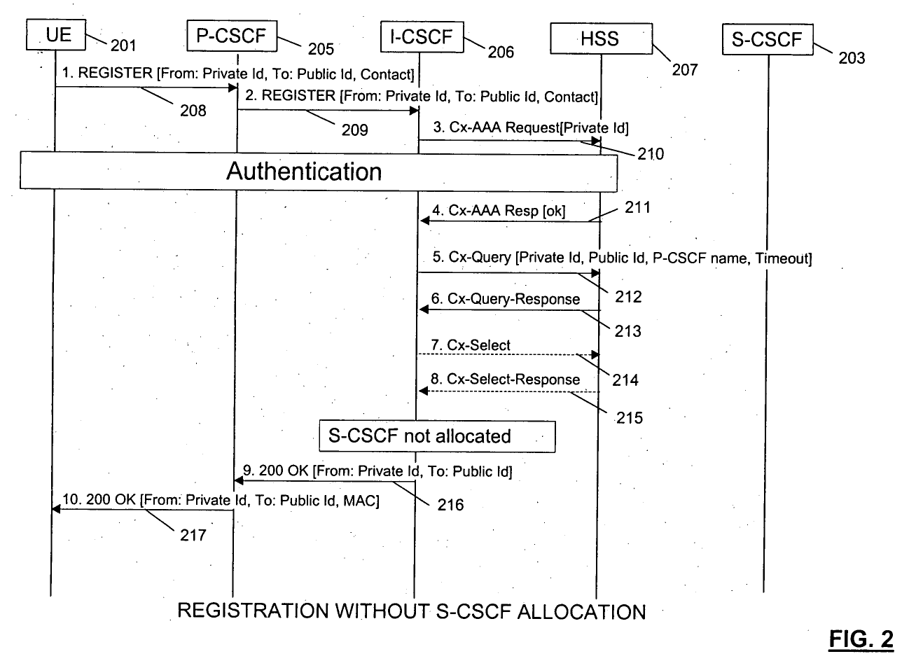

The above described network and network elements as well as their functions apply to the prior art system as well as to the system according to the present invention, in particular according to the preferred embodiments according ot FIGS. 2 to 4.

A conventional registration of the UE 101 will be described next with reference to FIG. 1.

After the concerned UE 103 roaming in the visited network 102 has obtained a signaling channel through the access network, it can perform the IM registration as described in 3GPP specification TS 23.228. To do so, the UE 101 sends in a first step a SIP REGISTER message 108 comprising a register information flow (subscriber identity, home network's domain name) to the P-CSCF 105 which examines the home domain name to determine the entry point (i.e. I-CSCF 106) to the home network 104 based on a name-address resolution mechanism.

Then, in a second step, the P-CSCF 105 sends a SIP REGISTER message 109 to the determined I-CSCF 106. The SIP REGISTER message 109 comprises register information (P-CSCF's name in the contact header, subscriber identity, visited network's contact name). Having received the register information, the I-CSCF 106 employs a name-address resolution mechanism to determine (e.g. based on the subscriber identity and home domain name) the address of the HSS 107 to be contacted.

Next, signaling flow shows the functional flows of the Cx interface. The Cx (interface between a CSCF and the HSS 107) registration signaling is performed in the next four steps. These steps are combined into two messages. All Cx steps may be combined between I-CSCF 106 and HSS 107 as well as between S-CSCF 103 and HSS 107. Even though the steps may also be defined differently, basic functionality of the Cx interface as shown in the signaling flow remains the same.

Firstly, a signalling is performed between the I-CSCF 106 and the HSS 107 to obtain the S-CSCF 103 capabilities at the I-CSCF 106. Based on these S-CSCF 103 capabilities, the I-CSCF 103 derives the address of the S-CSCF 103 by using an S-CSCF selection function and a name-address resolution mechanism.

To describe in detail, in the third step the I-CSCF 106 sends the Cx-Query information flow of a Cx-Query message 110 to the HSS 107. The Cx-Query message 110 comprises information as P-CSCF 105 name, subscriber 101 identity, home domain name and visited network 102 contact name. The P-CSCF 105 name denotes the contact name that the operator wishes to use for future contact to P-CSCF 105.

Upon receipt of the Cx-Query message 110 the HSS 107 determines whether UE 101 is already registered. Furthermore, the HSS 107 indicates whether UE 101 is allowed to register in the visited network 102 taking into account the UE subscription and operator limitations or restrictions.

In the fourth step HSS 107 sends a Cx-Query-response message 111 to the I-CSCF 106. In case the HSS 107 indicated that UE 101 is not allowed to register in the visited network 102 the Cx-Query response message 111 comprises an information indicating a rejection of the registration attempt of the UE 101.

In the fifth step it is assumed that the authentication of the UE 101 has been successfully completed although this might have been determined earlier in the information flows. It is noted that the authentication is not shown in the signaling flow of FIG. 1. In FIG. 2 it is shown as a ‘box’.

In this fifth step the I-CSCF 106 sends a Cx-select-pull message 112 to the HSS 107 to request information related to required S-CSCF 103 capabilities that are input into the S-CSCF 103 selection function. The Cx-Select-Pull message 112 comprises information about the serving network indication and the subscriber identity.

In the sixth step HSS 107 returns a Cx-Select-Pull response message 113 indicating the required S-CSCF 103 capabilities to the I-CSCF 106.

Then, in the seventh step the I-CSCF 106 sends a SIP REGISTER message 114 to the selected S-CSCF 103 which performs a Cx registration signaling with the HSS 107 in steps 8 to 11 in order to obtain information required to access a platform used for service control while the UE 101 is registered at its S-CSCF 103.

In particular in the seventh step the I-CSCF 106, using the name of the S-CSCF 103, determines the address of the S-CSCF through a name-address resolution mechanism and then sends the register information flow to the selected S-SCSF 103. The register information flow comprises the P-CSCF's name in the contact header, the subscriber identity and the visited network 102 contact name.

In the eighth step the S-CSCF 103 sends a Cx-Put message 115 to the HSS 107 indicating the subscriber identity and the S-CSCF 103 name that is stored in the HSS 107 for that subscriber 101.

In the ninth step the HSS 107 sends a Cx-Put response message 116 to the I-CSCF 106 in order to acknowledge Cx-Put message 115.

In the tenth step S-CSCF 103 sends a Cx-Pull message 117 indicating the subscriber identity to the HSS 117 in order to enable S-CSCF 103 to download the relevant information from the subscriber profile. Then, S-CSCF 103 stores the P-CSCF's name that has been supplied by the visited network 102. This P-CSCF's name represents the name that the home network 104 uses to forwarding subsequent terminating session signaling for the UE 101.

In the eleventh step HSS 107 returns a Cx-Pull response message 118 to the S-CSCF 103 indicating user information. This user information includes one ore more name/address information for use to access platforms used for service control, while the UE 101 is registered at this S-CSCF 103. The S-CSCF 103 stores this information for the respective UE 101. Furthermore, additional name/address information and security information can also be transmitted for use within the S-CSCF 103.

In the twelfth step S-CSCF 103 determines whether the home contact name is the S-CSCF name or an I-CSCF name. If an I-CSCF is chosen as the home contact name, it may be distinguished form the I-CSCF 106 that appears in the registration flow. This home contact name will be used by a P-CSCF 105 for forwarding signaling to the home network 104. Hence, the S-CSCF 103 sends a 200 OK SIP message 119 comprising the serving network contact name and the S-CSCF name to the I-CSCF 106.

Then, in the thirteenth step the I-CSCF sends a 200 OK SIP message 120 indicating the serving network contact name to the P-CSCF 105. The I-CSCF releases at this point all registration information after sending the 200 OK SIP message 120.

Then, P-CSCF 105 stores the serving network contact name and sends a 200 OK SIP message 120 to the UE 101.

According to the above described signaling the S-CSCF is allocated in the registration always or permanently. In the following preferred embodiments of the present invention are described, wherein the S-CSCF is allocated dynamically, i.e. from time to time, only when the S-CSCF is needed. However, in the preferred embodiments some parts of the above described prior art system are similar, including the network elements as well as parts of the signaling in between.

FIG. 2 shows the registration of a UE 201 without allocating the S-CSCF 203. UE 201, P-CSCF 205, I-CSCF 206, HSS 207 and S-CSCF 203 respectively correspond to UE 101, P-CSCF 105, I-CSCF 106, HSS 107 and S-CSCF as far as no deviations are described hereinafter.

UE 201 roams in a visited network and sends in a first SIP REGISTER message 208 indicating in a “from” header field a private identifier and indicating in a “to” header field a public identifier as well as a contact name. However, these header fields may also contain any other identity allowed by SIP specifications. This SIP REGISTER message 208 is send to P-CSCF 205. P-CSCF 205 forwards the content of the SIP REGISTER message 208 as a further SIP REGISTER message 209 to the I-CSCF 206.

Once the authentication is performed the I-CSCF 206 queries in a third step the HSS 207 whether the registration is allowed for the UE 201 by sending a Cx-AAA (AAA=Authentication, Authorization and Accounting) request message 210 comprising the above mentioned private identification. Thereby the Cx-AAA request message 210 actually starts the authentication if the HSS requires it.

In the fourth step HSS 207 sends a Cx-AAA response message 211 indicating whether the registration is allowed for UE 201 or not, i.e. the registration attempt should be rejected or accepted.

In the fifth step the I-CSCF 206 sends a Cx-Query message 212 to the HSS 207 comprising the identities, namely the private and the public identities of UE 201 as well as the P-CSCF 205 name indicating where the UE 201 is located at the moment. The P-CSCF 205 name is needed for routing the mobile terminated connection setups to the UE 201. Furthermore, a registration timeout value is sent in the Cx-Query message 212 indicating an registration expiration time. The registration timeout value is needed for monitoring the lifetime of the registration. As in the previous case described with reference to FIG. 1, these and the following Cx messages may be combined.

In the sixth step the HSS 207 returns a Cx-Query-Response message 213.

In the case the registration of the UE 201 is valid, the I-CSCF 206 may request information regarding the S-CSCF 203 capability requirements in the seventh step by sending a Cx-Select message 214. A corresponding Cx-Select-Response message 215 is returned from HSS 207 to I-CSCF 206. If the requirements are such that there is no need to allocate the S-CSCF 203, the I-CSCF 206 decides that it does not allocate the S-CSCF 203. Even though the I-CSCF 203 has requested the S-CSCF capability requirements information in the seventh step and has based its decision whether or not to allocate the S-CSCF (i.a.) on the information returned in step eight by Cx-Select-Response message 215, it is noted that this message exchange according to step 7 and 8 is not needed in case there is no additional information that the I-CSCF 206 needs to perform the decision whether or not to allocate the S-CSCF 203. Thus, step 7 and 8 and Cx-Select message 214 and Cx-Select-Response message 215 are just optional.

Furthermore, it is noted that the I-CSCF 206 may perform additional notification to the HSS 207 that the S-CSCF 203 was not allocated.

After the decision not to allocate the S-CSCF 203 the registration is acknowledged to the user 201, i.e. in a ninth step a SIP 200 OK message 216 is send from the I-CSCF 206 to the P-CSCF 205 which is forwarded from the P-CSCF 205 to UE 201 in a tenth step by transmitting a 200 OK SIP message 217 from the P-CSCF 205 to UE 201. Both 200 OK SIP messages 216 and 217 comprise the private identifier and the public identifier of the user 201.

Thus, I-CSCF has decided based on information received from HSS 207 or based on the decision of HSS whether or not to allocate S-CSCF in the registration. As I-CSCF 206 has decided in the case according to FIG. 2 that the S-CSCF 203 is not allocated, network resources have been saved.

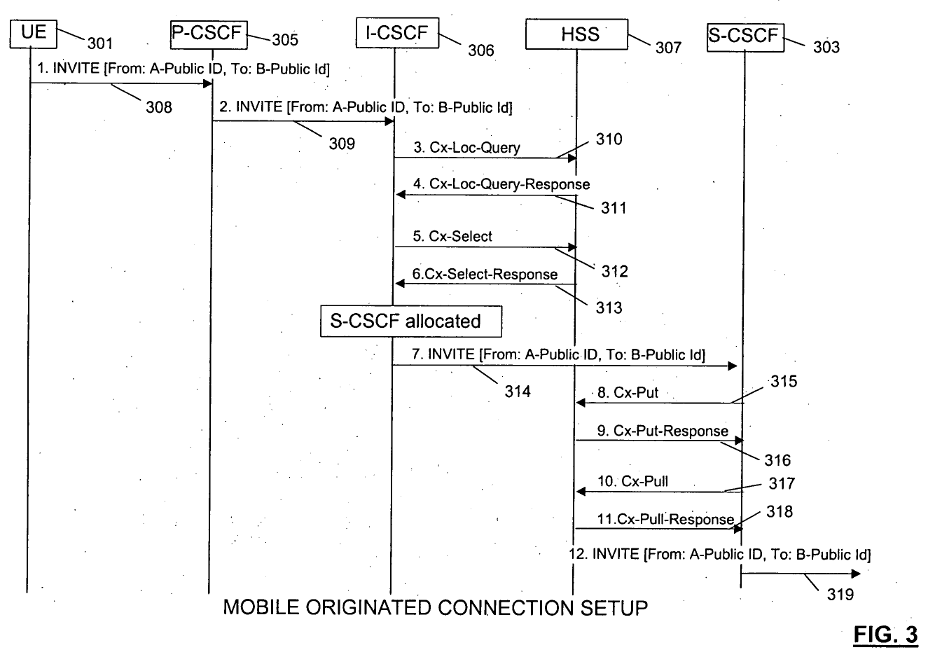

FIG. 3 shows a mobile originated connection setup procedure, i.e. a connection setup initiated from a mobile device, e.g. from UE 301. UE 301, P-CSCF 305, I-CSCF 306, HSS 307 and S-CSCF 303 correspond respectively to UE 201, P-CSCF 205, I-CSCF 206, HSS 207 and S-CSCF 203 as described above with reference to FIG. 2.

In a first step UE 301 sends a SIP INVITE message 308 to the P-CSCF 305 comprising a “from” header field indicating a public identifier of the calling party A, namely UE 301, and a “to” header field indicating a public identifier of a called party B.

In a second step the P-CSCF 305 forwards the message content from SIP INVITE message 308 as a further SIP INVITE message 309 to the I-CSCF 306.

In a third step the I-CSCF 306 sends a location query message Cx-Loc-Query 310 to the HSS 307 in order to locate the S-CSCF 303 for the user 301. A corresponding response message Cx-Loc-Query-Response 311 is returned from HSS 307 to I-CSCF 306 in a fourth step. Note that the User 301 may be allocated in this point or the authentication may be started from the S-CSCF 303 after a message 314 is sent from I-CSCF 306 to the S-CSCF 303 as described hereinafter.

In a fifth step a Cx-Select message 312 is sent from I-CSCF 306 to HSS 307 in order to request information regarding the S-CSCF capability requirements. The HSS 307 returns a corresponding Cx-Select-Response message 313 indicating information regarding the S-CSCF 303 capability requirements.

Next, the I-CSCF 306 decides on the received information whether or not to allocate the S-CSCF 303. However, it is also possible that the HSS 307 makes this decision and the I-CSCF 306 acts accordingly. In the example of FIG. 3, the I-CSCF 306 determines that no S-CSCF 303 has been allocated so far and based on the received information the I-CSCF 306 allocates the S-CSCF 303, when it has the information based on which it can perform the allocation.

In the seventh step the I-CSCF 306 sends a SIP INVITE message 314 to the S-CSCF 303 comprising the information contained in SIP INVITE message 309 that the I-CSCF 306 has received from P-CSCF 305.

In the eighth step the S-CSCF 303 may inform the location of the S-CSCF 303 to the HSS 307 by sending a Cx-Put message 315 to HSS 307. It is noted that if it is allowed that for other sessions another S-CSCF may used then the S-CSCF does not need to inform the location of the S-CSCF to the HSS 307. HSS 307 returns a corresponding Cx-Put-Response message 316 to S-CSCF 303 in order to acknowledge the sending of Cx-Put message 315 in a ninth step. In a tenth step the S-CSCF 303 requests subscriber information from the HSS 307 by sending a Cx-Pull message 317. In step eleven a subscriber information is send from HSS 307 to S-CSCF 303 by a corresponding Cx-Pull-Response message 318.

After these operations a SIP INVITE message 319 is forwarded from the S-CSCF 303 to the next hop which may be an application server or the network of the called party B.

It is noted that the I-CSCF 306 may also decide not to select any S-CSCF for the session if the I-CSCF 306 or HSS has determined that a S-CSCF is not needed for controlling the session. In this case signalling is directly performed from the I-CSCF 306 to the called user. Thus, network resources can be saved again.

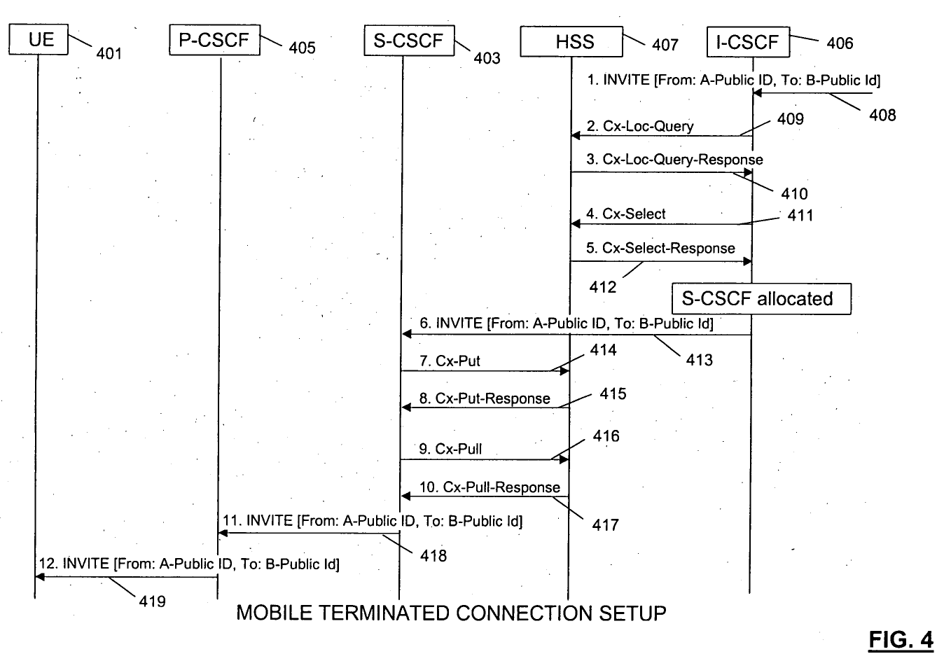

FIG. 4 shows a mobile terminated connection setup procedure, i.e. a connection setup that has been directed to a mobile device e.g. to UE 401. UE 401, P-CSCF 405, I-CSCF 406, HSS 407 and S-CSCF 403 correspond substantially to UE 201, P-CSCF 205, I-CSCF 206, HSS 207 and S-CSCF 203, respectively as being described above with reference to FIG. 2 or to UE 301, P-CSCF 305, I-CSCF 306, HSS 307 and S-CSCF 303, respectively, as described above with reference to FIG. 3.

In a first step I-CSCF 406 receives a SIP INVITE message 408 from a calling party A (not shown). The SIP INVITE message 408 comprises a “from” header field indicating a public identifier of the calling party A and a “to” header field indicating a public identifier of a called party B, namely UE 401.

In a second step I-CSCF 406 sends a location query message Cx Loc-Query 409 to the HSS 407 in order to locate the S-CSCF for the user 401. A corresponding response message Cx-Loc-Query-Response 410 is returned from HSS 407 to I-CSCF 406 in a fourth step indicating the P-CSCF 405 name where the user 401 is located.

In a fourth step a Cx-Select message 411 is sent from I-CSCF 406 to HSS407 in order to request information regarding the S-CSCF capability requirements. The HSS 407 returns a corresponding Cx-Select-Response message 412 indicating information regarding the S-CSCF 403 capability requirements.

Next, I-CSCF 406 or HSS 407 decides whether or not to allocate the S-CSCF 403, in particular it is determined whether the S-CSCF has already been allocated. In the example of FIG. 4 there is no S-CSCF allocated and the I-CSCF 406 allocates the S-CSCF 403 after step 5 when I-CSCF 406 has the information based on which it can perform an allocation.

In step 6 I-CSCF 406 sends a SIP INVITE message 413 to S-CSCF 403 comprising the information contained in SIP INVITE message 408 that the I-CSCF 406 has received in step 1. Thereby, also the P-CSCF 405 name is forwarded to the S-CSCF 403 for routing the setup. The P-CSCF name may be provided to the S-CSCF 403 from the HSS 407 when the S-CSCF 403 ‘pulls’ the subscriber information from the HSS 407, i.e. in message 416 described hereinafter. Similarly as in the case described with reference to FIG. 3 the S-CSCF 403 may inform the location of the S-CSCF 403 to the HSS by sending a Cx-Put message 414 in step 7. HSS 407 returns in a eighth step a corresponding Cx-Put-Response message 415 to S-CSCF 403 in order to acknowledge the sending of Cx-Put message 414.

In step 9 the S-CSCF 403 requests the subscriber information from the HSS 407 by sending a Cx-Pull message 416. In step 10 the requested subscriber information is sent from HSS 407 to S-CSCF 403 by a corresponding Cx-Pull-Response message 417.

Next the setup is routed to the P-CSCF 405, i.e. the S-CSCF 403 sends a SIP INVITE message 418 to P-CSCF 405 in step 11, whereby this SIP INVITE message 418 comprises the information contained in SIP message 408 or 413. Then, in step 12 a further SIP INVITE message 419 is forwarded from P-CSCF 405 to UE 401 comprising the information contained in SIP INVITE message 418.

It is noted that the I-CSCF 406 may not select any S-CSCF for the session if the I-CSCF 406 decides that no S-CSCF is needed for controlling the session. In this case the session signalling goes directly from the I-CSCF 406 to the called user UE 401.

The present invention allows due to the dynamical allocation of the S-CSCF on the basis of a decision made by the I-CSCF or the HSS a more efficient network resource usage as no S-CSCFs need to be reserved for inactive users that do not actually need a S-CSCF. Thus, network resources are saved as a permanent allocation of the S-CSCF is avoided.

It is noted that the present invention is however not restricted to the preferred embodiments described above, in particular any other kind of SIP messages besides REGISTER and INVITE messages can be transmitted via the network elements. Furthermore, the present invention can be implemented in any fixed or wireless network environment using any kind of session initiation protocols in packet switched networks as well as in circuit switched networks as well as in combined packet switched an circuit switched networks, in particular 3GPP specified networks. The preferred embodiments may thus vary within the scope of the attached claims.

1-28. (Cancelled).

29. A method for controlling data transmission in a network environment by means of a first control function and a second control function, said network environment comprising an Internet Protocol Multimedia Subsystem employing the Session Initiation Protocol, wherein said first and second control functions are call state control functions for sessions associated with a user equipment within said Internet Protocol Multimedia Subsystem, wherein said first control function is an interrogating call state control function and said second control function is a serving call state control function, and wherein said method comprises the step of allocating said second control function dynamically under command of said first control function in response to a determination that said user equipment is active in a network transaction being processed.

30. A method according to claim 29, wherein said network transaction is a registration of a user or a setup or termination of a session.

31. A method according to claim 29, wherein said allocating step is based on a decision made under command of said first control function or under command of a first network element comprising said first control function to allocate said second control function dynamically.

32. A method according to claim 29, wherein said allocating step is based on a decision made under command of a further control function or under command of a further network element comprising said further control function to allocate said second control function dynamically.

33. A method according to claim 32, wherein said further control function is a home subscriber server or home subscriber data base.

34. A method according to claim 29, wherein said first control function is an interrogating call state control function and said second control function is a serving call state control function.

35. A method according to claim 29, wherein said serving call state control function stores subscriber specific information.

36. A method according to claim 29, wherein said second control function is dynamically allocated only when it is actually needed in order to avoid a permanent allocation and thus saving network resources.

37. A method according to claim 29, comprising the further steps of:
a) receiving a first message under command of said first control function,
b) sending a second message to said home subscriber data base under command of said first control function in response to said first message,
c) receiving a third message from said home subscriber data base under command of said first control function in response to said second message, and
d) deciding under command of said first control function based on said third message whether or not to allocate said second control function.

38. A method according to claim 29, wherein said network environment comprises a home network of a user and a visited network said user roamed into, wherein said home network comprises said first and second control functions and said further control function.

39. A method according to claim 37, wherein said first message is a SIP INVITE message or a SIP REGISTER message.

40. A method according to claim 37, wherein said second message is a request message requesting whether a registration is allowed for said user and said third message indicates whether or not a registration is allowed for said user.

41. A method according to claim 37, further comprising the step of sending under command of said first control function a fourth message to said home subscriber data base for requesting information regarding capability requirements of said second control function.

42. A method according to claim 29, further comprising the step of sending under command of said first control function a notification message to said home subscriber data base indicating that said second control function was not allocated in case said first control function decides not to allocate said second control function.

43. A method according to claim 29, wherein an acknowledge message is directed to said user in order to indicate a successful registration and is send via said third control function.

44. A method according to claim 37, wherein said first message is transmitted from a third control function being a proxy call state control function.

45. A method according to claim 37, wherein said second message is a location query message for requesting location information referring to said second control function enabling to allocate said second control function.

46. A method according to claim 29, further comprising the step of forwarding a SIP INVITE message to said second control function under command of said first control function in case said first control function decides to allocate said second control function wherein said SIP INVITE message is forwarded towards a called party under command of said second control function.

47. A method according to claim 46, wherein a message is sent under command of said second control function to said home subscriber data base comprising location information referring to said second control function and further a message is sent under command of said second control function to said home subscriber data base requesting subscriber information.

48. A method according to claim 29, further comprising the step of forwarding a SIP INVITE message to said called party under command of said first control function in case said first control function decides not to allocate said second control function.

49. A method according to claim 37, wherein said third message indicates an identifier of a proxy call state control function where said called party is located and said identifier is forwarded to said second control function under command of said first control function.

50. A method according to claim 29, wherein said home subscriber data base stores a registration expiration time indicating a maximum registration time.

51. A system for controlling data transmission in a network environment, comprising means for performing a first control function and means for performing a second control function, said network environment comprising an Internet Protocol Multimedia Subsystem employing the Session Initiation Protocol, wherein said first and second control functions are call state control functions for sessions associated with a user equipment within said Internet Protocol Multimedia Subsystem, wherein said first control function is an interrogating call state control function and said second control function is a serving call state control function, and wherein said means for performing said first control function comprises allocating means for allocating said second control function dynamically in response to a determination that said user equipment is active in a network transaction being processed.

52. A system according to claim 51 further comprising a home subscriber data base, whereby
a) said means for performing said first control function comprises means for receiving messages and means for transmitting messages from/to said home subscriber data base, and
b) said means for performing said first control function and/or said home subscriber data base comprises decision means being in communication with said allocating means and for deciding whether or not to allocate said second control function in said first control function or said home subscriber data base on the basis of a third message received from said home subscriber data base in response to a second message sent from said means for performing said first control function to said home subscriber data base in response to a first message received by said receiving means.

53. A system according to claim 51, wherein said home subscriber data base being a home subscriber server.

54. A system according to claim 51, further comprising means for performing the step of allocating said second control function dynamically under command of said first control function in response to a determination that said user equipment is active in a network transaction being processed.

55. A network element for controlling data transmission in a system according to claim 51, said network element comprising means for performing a first control function, said means for performing said first control function comprising allocating means for allocating a second control function dynamically in response to a determination that said user equipment is active in a network transaction being processed.

56. A network element according to claim 55, wherein said means for performing said first control function comprises decision means being connected with said allocating means and for deciding whether or not to allocate a further control function.
